(19) United States
(12) Patent Application Publication
(10) Pub. No.: US 2006/0203674 A1
(43) Pub. Date: Sep. 14, 2006

(54) Record carrier, device and method for correcting signed deviation

(75) Inventors: Gerard Elise Noel Schreurs, Eindhoven (NL); Gerardus Rudolph Langereis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/564,390

(22) PCT Filed: Jul. 15, 2004
(86) PCT No.: PCT/IB04/51232

§ 371 Date: Jan. 12, 2006

(30) Foreign Application Priority Data
Jul. 17, 2003 (EP) 03102199.1

(51) Int. Cl. G11B 7/0045

(52) U.S. Cl. 369/59.11

(57) ABSTRACT

A device for recording information in a track on a record carrier writes and reads marks and spaces each having a nominal run length. The device has a detection unit (32) for generating a signed deviation value signal (34) indicative for a position deviation of a starting edge of a mark and/or an ending edge of a mark with respect to a nominal, position of said edge. A calculation unit (31) selects at least one predefined run length pattern and determines a correction signal (33) based on at least one statistically calculated parameter of the signed deviation value signal for the selected run length pattern. A radiation source control unit (29) controls the power of the radiation source during said writing based on the correction signal.

The invention relates to a device for recording information in a track on a record carrier, the device comprising a head for generating a beam of radiation for writing marks and spaces between the marks, and for generating at least one read signal in dependence on the marks and spaces, the marks and spaces each having a nominal run length of a predetermined number of bits, and the run lengths constituting a recorded pattern having a multitude of different run lengths for representing the information.

The invention further relates to a method of controlling the power of a radiation source during recording information in a track on a record carrier, the method comprising writing and reading marks and spaces between the marks, the marks and spaces each having a nominal run length of a predetermined number of bits, and the run lengths constituting a recorded pattern having a multitude of different run lengths for representing the information.

The invention further relates to a record carrier of a recordable type.

A method and apparatus for recording information on a record carrier are known from U.S. Pat. No. 5,303,217. The record carrier is of a recordable type and has a track for recording information, e.g. a spiral shaped track on a disc shaped carrier indicated by a wobbled pregroove. The device comprises a drive unit for rotating the record carrier. For scanning the track an optical head is positioned opposite the track by a positioning unit, while the record carrier is rotated. The head has a laser and optical elements for generating a beam of radiation for writing marks and intermediate spaces. The length of a mark or space has a nominal value of a predetermined number of units of length, usually called a run length measured in (channel) bits, and the marks and spaces constitute a recorded pattern for digitally representing the information according to a modulation code, usually called channel code. A read signal is generated from the marks by a detector receiving reflected radiation via a scanning spot on the track. The device has a control unit for controlling the laser power to a desired value during writing. Further the control unit comprises a unit for determining an asymmetry signal based on a read signal of a test pattern, the read signal having positive and negative peak values relative to a DC signal. The asymmetry signal is a measure for the correspondence of the marks to desired lengths thereof. The desired value of the laser power is set in dependence on the asymmetry signal for generating marks and intermediate spaces having a predefined ratio of lengths, said ratio being equal to the ratio of the signal representing the information. A problem is that the lengths of the marks are deviating from the expected values.

It is an object of the invention to provide a recording device and corresponding method for achieving marks and spaces that correspond to the desired lengths.

For this purpose, the device as described in the opening paragraph has detection means coupled to the read signal for generating a signed deviation value signal indicative for a position deviation of a starting edge of a mark and/or an ending edge of a mark with respect to a nominal position of said edge, calculation means for selecting at least one predefined run length pattern and determining a correction signal based on at least one statistically calculated parameter of the signed deviation value signal for the selected run length pattern, and radiation source control means for controlling the power of the radiation source during said writing in dependence of the correction signal.

The method as described in the opening paragraph comprises generating a signed deviation value signal indicative for a position deviation of a starting edge of a mark and/or an ending edge of a mark with respect to a nominal position of said edge, selecting at least one predefined run length pattern, determining a correction signal based on at least one statistically calculated parameter of the signed deviation value signal for the selected run length pattern and controlling the power of the radiation source during said writing in dependence of the correction signal.

The effect of the measures is that statistical information is derived form the recorded pattern of marks and spaces. Writing on high density optical media requires a write strategy that is carefully controlling the radiation beam during writing patterns of marks and spaces. The correction signal is calculated for adjusting settings in the write strategy. Advantageously, settings in the write strategy can be corrected based on deviations occurring at a specific run length patterns. Statistical data for determining a parameter for adjusting a specific setting can be selectively extracted from recorded information.

The invention is based on the following recognition. Unsigned measurements of deviations, such as jitter measurements, can only be used to correct settings of a write strategy when using test patterns recorded at different settings. For example US2001/0043529 describes determining an optimum level of recording power using test patterns at different power levels. Phase differences between PLL clock signals and data edges are detected to find a threshold power level at which a predetermined percentage of jitter occurs. The threshold power level is multiplied by a constant to provide the optimum level. The inventors have seen that different measurements can be selectively extracted from a versatile test pattern or, in particular, even from normal information recorded at the best settings known. First the inventors have proposed to detect a signed value indicative for the deviation of the actual run length or edge position from the nominal value. Secondly the inventors have proposed to selectively extract measurements for predefined run lengths or run length patterns to find adjustments for specific settings of the write strategy.

In an embodiment of the device the calculation means are arranged for calculating a mean value of the runlength between the starting edge and the ending edge of marks as the parameter of the signed deviation value signal. This has the advantage that the runlength of the marks or spaces that are selected for determining the deviation signal can be corrected.

In an embodiment of the device the calculation means are arranged for calculating a mean value of the position deviation of the starting edge and/or the ending edge as the parameter of the signed deviation value signal. This has the advantage that settings of the write strategy that determine the start or the end of the mark can be adjusted separately.

In an embodiment of the device the calculation means are arranged for calculating a pre-heat effect of a mark in dependence of the space preceding the starting edge of the mark by comparing a first mean value calculated for a relative short space before the mark and a second mean value calculated for a relative long space before the mark. This has the advantage that the preheat effect is detected in the actual record carrier, and any variations due to material differences or aging can be corrected by adjusting settings in the write strategy influencing the first part of a mark in dependence of the preceding space.

In an embodiment of the device the detection means are arranged for generating the signed deviation value signal during said writing, during which writing the radiation source control means are controlling the power of the radiation source at an optimum power according to predefined settings and/or previously generated values of the correction signal, by temporarily interrupting said writing and during said interruption reading a part of the recorded pattern for generating the read signal. This has the advantage that the writing strategy is updated and optimized during writing of user information.

According to a further aspect of the invention, the record carrier as described in the opening paragraph has a track for recording information, the recording comprising writing and reading marks and spaces between the marks, the marks and spaces each having a nominal run length of a predetermined number of bits, and the run lengths constituting a recorded pattern having a multitude of different run lengths for representing the information, and an optimum power control process including generating a signed deviation value signal indicative for a position deviation of a starting edge of a mark and/or an ending edge of a mark with respect to a nominal position of said edge, selecting at least one predefined run length pattern, determining a correction signal based on at least one statistically calculated parameter of the signed deviation value signal for the selected run length pattern and controlling the power of the radiation source during said writing in dependence of the correction signal, the record carrier comprising prerecorded control information for adjusting the optimum power control process. This has the advantage that the optimum power control process can be adjusted by the manufacturer of the record carrier by including specific parameters, e.g. offsets, to include in the correction calculation for the writing strategy.

Further embodiments are given in the dependent claims.

These and other aspects of the invention will be apparent from and elucidated further with reference to the embodiments described by way of example in the following description and with reference to the accompanying drawings, in which

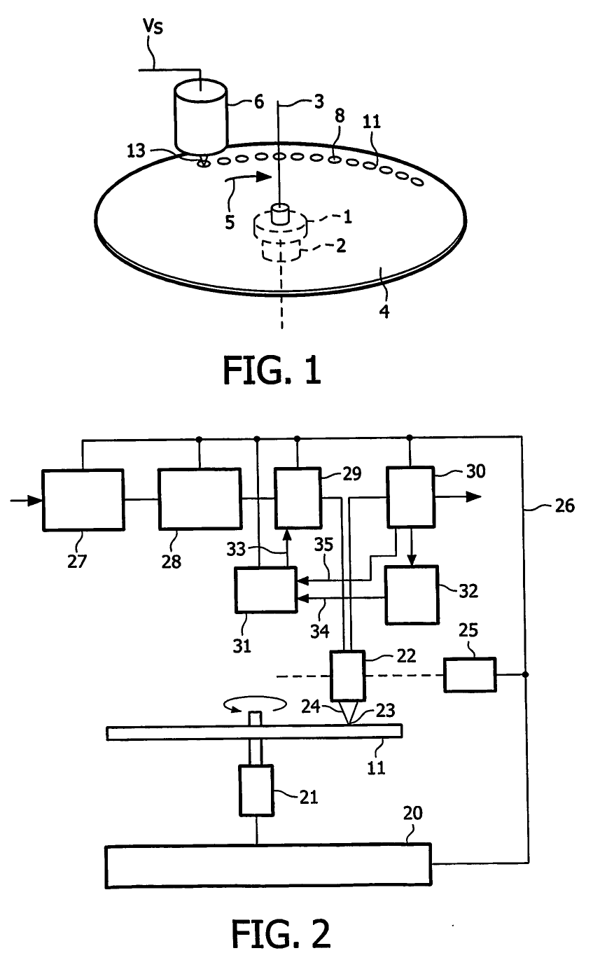

FIG. 1 shows diagrammatically a customary optical recording device,

FIG. 2 shows a recording device,

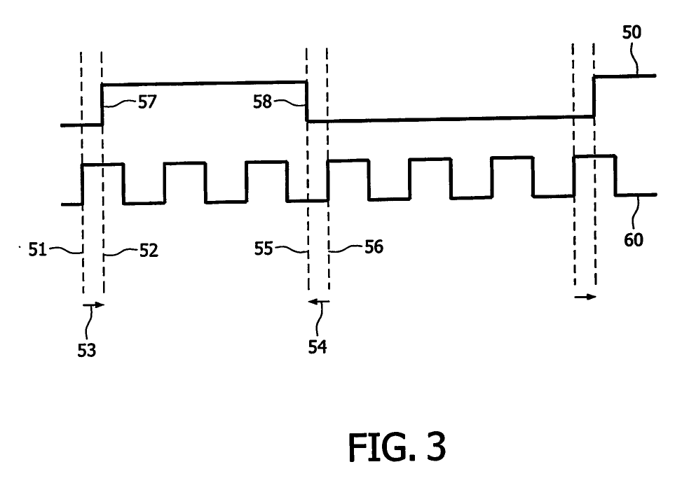

FIG. 3 shows a signed deviation value,

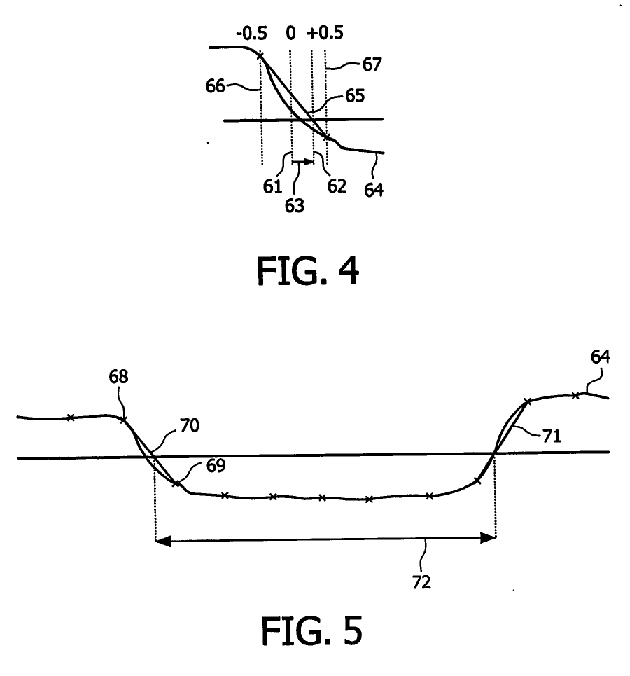

FIG. 4 shows detecting deviation of a leading edge,

FIG. 5 shows measurement of a run length,

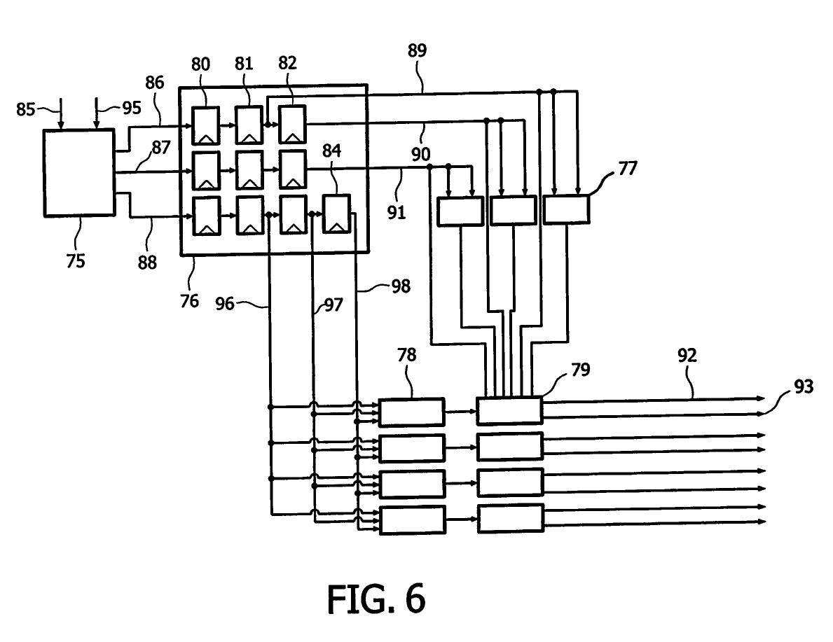

FIG. 6 shows a diagram of a detection and calculation circuit, and

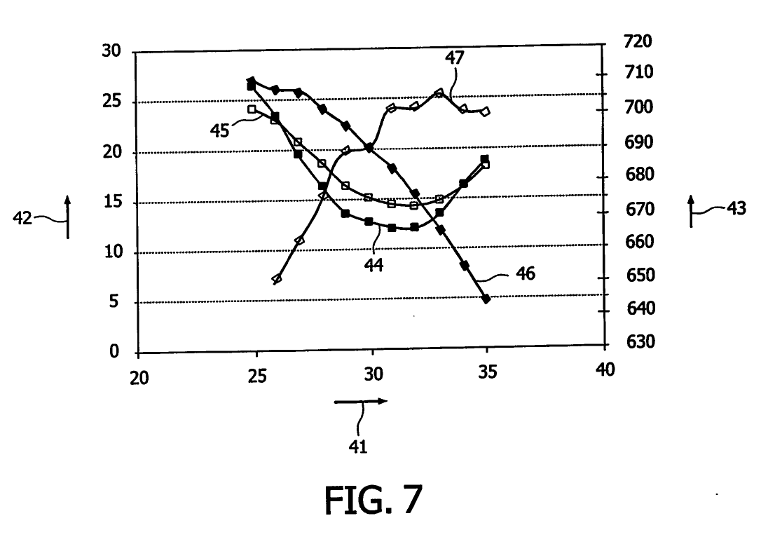

FIG. 7 shows a measurement of run lengths.

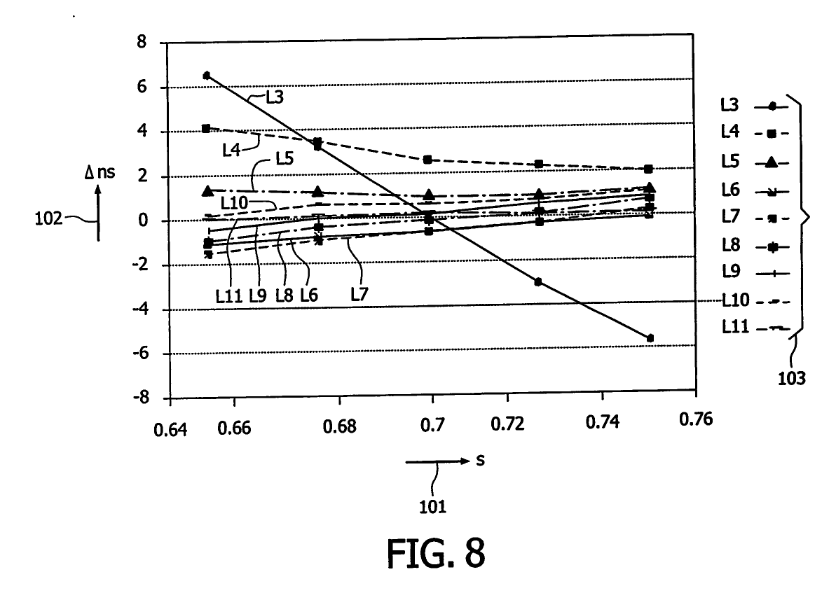

FIG. 8 shows a graph of the ratio of power as a function of the optimal run length.

Corresponding elements in different Figures have identical reference numerals.

FIG. 1 shows diagrammatically an optical recording device, comprising a turntable 1 and a drive motor 2 for rotating a disc shaped record carrier 4 about an axis 3 in a direction indicated by an arrow 5. The record carrier has a track 11 for recording marks 8, the track being located by a servo pattern for generating servo tracking signals for positioning an optical head opposite the track. The servo pattern may for example be a shallow wobbled groove, usually called a pre-groove, and/or a pattern of indentations, usually called pre-pits or servo pits. The record carrier 4 comprises a radiation-sensitive recording layer which upon exposure to radiation of sufficiently high intensity is subjected to an optically detectable change, such as for example a change in reflectivity, for forming marks 8 and intermediate spaces constituting a recorded pattern representing information. In the pattern each element has a nominal run length expressed in units called bits. The run lengths represent the information according to a modulation scheme usually called channel code.

The radiation-sensitive layer may comprise, for example, a thin metal layer which can be removed locally by exposure to a laser beam of comparatively high intensity. Alternatively, the recording layer may consist of another material such as a radiation sensitive dye or a phase-change material, whose structure can be changed from amorphous to crystalline or vice versa under the influence of radiation. An optical write head 6 is arranged opposite the track of the (rotating) record carrier. The optical write head 6 comprises a radiation source, for example a solid-state laser, for generating a write beam 13. The intensity I of the write beam 13 is modulated in conformity with a control signal in a customary manner. The intensity of the write beam 13 varies between a write intensity, which is adequate to bring about detectable changes in the optical properties of the radiation-sensitive record carrier for forming a mark, and a low (or zero) intensity, which does not bring about any detectable changes for creating an intermediate area in between the marks further called space. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material.

The system of controlling the write power for creating a mark is adapted to the pattern that has to be recorded, which is called a write strategy. In high density recording sophisticated write strategies are implemented, e.g. controlling the write power in dependence of the length of the mark to be written and/or size of the preceding space. The parameters in the write strategy that determine the write power in dependence of time and the pattern to be recorded are called settings of the write strategy.

For reading the recording layer is scanned with a beam 13 whose intensity is at a reading level of a constant intensity which is low enough to preclude a detectable change in optical properties. During scanning the read beam reflected from the record carrier is modulated in conformity with the information pattern being scanned. The modulation of the read beam can be detected in a customary manner by means of a radiation-sensitive detector which generates a read signal which is indicative of the beam modulation.

FIG. 2 shows a recording device for writing and/or reading information on a record carrier 4 of a type which is writable or re-writable, for example CD-R or CD-RW, or a recordable DVD. The device is provided with scanning means for scanning the track on the record carrier which means include a drive unit 21 for rotating the record carrier 4, a scanning unit 22 comprising an optical head and additional circuitry, a positioning unit 25 for coarsely positioning the optical head in the radial direction on the track, and a control unit 20. The optical head comprises an optical system of a known type for generating a radiation beam 24 guided through optical elements focused to a radiation spot 23 on a track of the information layer of the record carrier. The optical head and additional circuits constitute a scanning unit for generating signals detected from the radiation beam. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. For reading the radiation reflected by the information layer is detected by a detector of a usual type, e.g. a four-quadrant diode, in the optical head for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the optical head, the positioning unit 25 and the read processing unit 30. The device comprises write processing means for processing the input information to generate a write signal to drive the optical head, which means comprise an input unit 27, and a formatter 28 and a laser power unit 29. The control unit 20 controls the recording and retrieving of information and may be arranged for receiving commands from a user or from a host computer. The control unit 20 is connected via control lines 26, e.g. a system bus, to said input unit 27, formatter 28 and laser power unit 29, to the read processing unit 30, and to the drive unit 21, and the positioning unit 25. The control unit 20 comprises control circuitry, for example a microprocessor, a program memory and control gates, for performing the writing and/or reading functions. The control unit 20 may also be implemented as a state machine in logic circuits.

In an embodiment the device is a storage system only, e.g. an optical disc drive for interfacing to a computer. Alternatively the device includes application data processing, e.g. audio and/or video processing circuits in a consumer recorder. In either case digital data is stored on the record carrier according to a predefined data format. Writing and reading of information for recording on optical disks and usable formatting, error correcting and channel coding rules are well-known in the art, e.g. from the CD system. User information is presented on the input unit 27, which may comprise of compression means for input signals such as analog audio and/or video, or digital uncompressed audio/video. Suitable compression means are for example described for audio in WO 98/16014-A1 (PHN 16452), and for video in the MPEG2 standard. The input unit 27 processes the audio and/or video to unit of information, which are passed to the formatter 28. For computer applications data may be interfaced to the formatter 28 directly.

The formatter 28 is for adding control data and formatting and encoding the data according to the recording format, e.g. by adding error correction codes (ECC), interleaving and channel coding. Further the formatter 28 comprises synchronizing means for including synchronizing patterns in the modulated signal. The formatted units comprise address information and are written to corresponding addressable locations on the record carrier under the control of control unit 20. The formatted data from the output of the formatter 28 is passed to the laser power unit 29, which generates a laser power control signal which drives the radiation source in the optical head.

The device has a detection unit 32 coupled to the read signal via the read processing unit 30. The detection unit 32 generates a signed deviation value signal 34 that is indicative for a position deviation of a starting edge of a mark and/or an ending edge of a mark with respect to a nominal position of said edge. For example the position of the edge is compared to a clock signal recovered via a phase locked loop (PLL) from the read signal.

FIG. 3 shows a signed deviation value. An upper curve 50 shows a read signal based on a pattern of a mark and a space both having a nominal run length of 3 bits. A lower curve 60 shows a recovered PLL clock. A starting edge 57 of the mark is located at an actual position 52. A corresponding clock edge of the PLL clock indicates the nominal position 51. The mark start too late and hence the actual position 52 is after the nominal position 51. The arrow 53 indicates a deviation, in fact amplitude and sign of the deviation, between the nominal and the actual position of the starting edge of the mark. An ending edge 58 of the mark is located at an actual position 55. A corresponding clock edge of the PLL clock indicates the nominal position 56. Hence the actual position 55 is before the nominal position 56. The arrow 54 indicates the amplitude and sign of the deviation, between the nominal and the actual position of the ending edge of the mark. The position in time of the edge is compared to the corresponding clock edge of the PLL clock signal. In the example the starting edge of the mark arrives after the clock edge, and a positive value is assigned for the deviation, and vice versa. Hence a signed value is available for the deviation.

The device has a calculation unit 31 coupled to the signed deviation value signal 34. The calculation unit generates a correction signal 33 coupled to the laser power unit 29 for adjusting settings in the control system for the laser power, i.e. the write strategy. The unit receives a detected signal 35 from the read processing unit indicative for the pattern of marks and spaces that is retrieved from the read signal for selecting a pattern of run lengths. Only for the selected pattern the value of the signed deviation value signal 34 is evaluated. In an embodiment a number of patterns are selected and for each pattern the signed deviation value signal 34 is evaluated separately for generating a number of correction signals for different settings of the write strategy. For example in the selected run length pattern marks and/or spaces nominally have a single predefined run length, or run lengths in a limited range of run lengths. Alternatively a pattern is a run length sequence including at least a mark and at least one space having predefined run lengths, or having lengths within a predefined range. For the selected pattern a correction signal 33 is determined based on at least one statistically calculated parameter of the signed deviation value signal for the selected run length pattern, for example a mean value averaged over a period of time, e.g. fixed or until a predetermined number of occurrences of the selected pattern.

In an embodiment of the device the calculation means 31 are arranged for calculating a mean value of the position deviation of the starting edge and/or the ending edge as the parameter of the signed deviation value signal. Based on the position of the starting edge a power setting in the write strategy for the power at the beginning of a mark can be adjusted. Based on the position of the ending edge a power setting in the write strategy for the power at the end of a mark can be adjusted.

It is noted that in practical embodiments the functions of detection the signed deviation value signal 34, selecting the pattern, calculating the correction signal 33 and controlling the laser power may be performed in a different combination or in different units, e.g. a in single unit or (in part) in the control unit 20. Further said signals 33,34,35 between the units may be embodied as digital data, e.g. via transferred the system bus 26, or stored in a common memory.

In an embodiment the calculation unit 31 is arranged for calculating a mean value of the runlength between the starting edge and the ending edge of marks as the parameter of the signed deviation value signal. For example the run lengths of marks and spaces having a nominal length of 3 bits are selected and averaged.

FIG. 4 shows detecting deviation of a leading edge. A nominal position 61 indicates the desired position of a leading edge of a mark, represented by a reading signal 64. In a practical system the reading signal is sampled at instants −0.5 and +0.5 determined by a clock, indicated by samples 66 and 67. The leading edge deviation is calculated based on the same linear interpolation. For the leading edge, only the zero crossing of the linear interpolation on the left of the current symbol is taken into account. The deviation 63 between this zero crossing 62 and the half of the interval (nominal position 61) between the two samples is taken as the leading edge deviation.

If the zero crossing comes too early the leading edge deviation will be negative, a too late crossing will lead to the leading edge deviation to be positive. The trailing edge deviation of a symbol is equal to the leading edge deviation of the next symbol. Hence, the trailing edge deviation can be determined by the interpolation for the next leading edge. The described method implicates that the recovered bit clock is taken as a reference for the sample measurements, so the PLL has to be in lock to allow correct measurements.

FIG. 5 shows measurement of a run length. A read signal 64 is shown having sampled values at regular instants. Between two sampled values 68,69 of opposite sign an interpolation 70 is made that determined the start of the run length 72. The end of the run length is set by a next interpolation 71 for sample having an opposite sign. In a practical embodiment first the DC level of incoming samples (for example taken asynchronously) is put to zero. Then the samples are re-sampled in a sample rate converter, using the bit clock that is recovered by the PLL. When the samples after re-sampling show a sign reversal (i.e. a zero crossing is found), a linear interpolation is done between the resampled sample on the right and the resampled sample on the left of the zero crossing. The location where this linear interpolation crosses the zero level, will be taken as the boundary between the symbol on the left and right of the zero crossing. The measured runlength is the length between the left and the right boundary of the effect. The runlength deviation is the difference between the measured runlength and the ideal integer runlength. The values are represented by a digital number of an integer and a fraction. The ideal integer runlength is specified as the rounded version of the measured runlength.

FIG. 6 shows a diagram of a detection and calculation circuit. A deviation detection circuit 75 receives information signals 85 from the zero cross detector in the HF signal and the recovered PLL clock signal 95. A leading edge deviation signal 86 is generated, for example generated as described above with FIG. 4. A run length deviation signal 87 is generated, for example generated as described above with FIG. 5. In addition a size signal 88 indicating the rounded run length and sign is generated (indicating the size and type of a symbol, i.e. mark/pit or space/land). The signals 86,87,88 are coupled to a buffer unit 76, which has for each signal a sequence of buffers. The signals are shifted to the next buffer after detecting a next edge. The leading edge signal 86 is entered in an initial buffer 80 coupled to a first subsequent buffer 81, and thereafter coupled to a second buffer 82. The size signal also has a third buffer 84. The integer runlength and a sign bit of the symbol are fed into the buffer to be able to give a sequence of three subsequent runlength size signals (rounded previous, current and next symbol run lengths) and one sign bit (current symbol sign bit) to comparison units 78.

The outputs of the fist and second buffer for the edge deviation signal 86 provide an leading edge deviation signal 90 on a present leading edge and a trailing edge deviation signal 89 on a present trailing edge (=next leading edge), and are coupled to a number of squaring units 77 (three are shown) for calculation corresponding squared deviation signals. The deviation signals and the corresponding squared deviation signals are coupled to inputs of filter units 79. The outputs of the fist, second and third buffer for the size signal, respectively provide a future size signal 96 on a future symbol, a present size signal 97 on a present symbol and a past size signal 98 on a previous symbol, and are coupled to a number of selection circuits 78. The selection circuit selects only a predetermined sequence of sizes and or types. If the respective sequence is found, the selection circuit 78 sends an enable signal to a corresponding filter unit 79, which then takes a new set of values from the deviation values. The entered deviation values are filtered, e.g. by calculating a mean value, and are provided as an output correction value 92 and a mean squared correction value 93. The correction values 92,93 may be used for directly changing settings of a write strategy, or may be used in a further calculation in a central processing unit for combining correction values of different measurements for changing the write parameters. The buffer 76 allows checking whether the detected symbol matches with the conditions of the one of the required measurements. When the current symbol fulfils the conditions for one of the measurements, the runlength deviation, leading edge deviation or trailing edge deviation (depending on the settings for that particular measurement unit) of the current symbol as well as their respective squares, will be taken into account in the corresponding filter unit 79. It is noted that any number of parallel measurements can be included by taking the required number of selection units 78 and filter units 79 (four sets are shown). In general the function of the circuit in FIG. 6 is an embodiment of the detection unit 32 and the calculation unit 31 in FIG. 2.

In an embodiment the device has a first write strategy for recording marks having an odd run length and a second write strategy for recording marks having an even run length, usually called 2T write strategies. By selectively extracting measurements for even and odd run lengths both write strategies can be optimized.

In an embodiment the selection units 78 are providing a measurement under a predetermined set of conditions such as:
the previous symbol has runlength M, M+ or M++
the current symbol has runlength N, N+ or N++
the next symbol has runlength O, O+ or 0++
the current symbol is land/pit
M means the runlength is equal to M bit lengths (nominal value)
M+ means the runlength is M or longer
M++ means the runlength is M, M+2, M+4, M+6, . . . (useful for 2T write strategies)
   Obviously other conditions may be added for more complicated measurements.

In an embodiment the filter units 79 are provided with statistical postprocessing functions. Basically low pass filtering is applied, e.g. a mean value is calculated. When the data in the buffer matches the conditions for the corresponding measurements, the deviation will be taken into account in the low pass filtering of that measurement unit to generate a measure for the mean of this deviation (‘mean’), as well as a mean of the squared deviation for generating a measure for the mean of the squared deviation (‘square of jitter’). In an embodiment a counter, that gives an indication on how much different symbols this measurement is based, is incremented. To be ‘taken into account in the low pass filtering’ means that the input sample of the low pass filter is updated with the new value. When there is no update, the input sample remains at the previous value (‘hold’). The low pass filters 79 run on bit clock (fbit), so they have a cutoff frequency that scales with that clock.

FIG. 7 shows a measurement of run lengths. In a horizontal direction 41 the write power in mW is indicated for a laser radiation source. In a vertical direction 42 a jitter percentage is given for a mark jitter curve 45 and a space jitter curve 44. In a further vertical direction 43 a length in ns is given for a mark length curve 47 and a space length curve 46. The run lengths of the mark and space selected, i.e. I3, are 3 bit lengths, which in the record carrier at the speed used for the test corresponds to 3*231 ns=693 ns. From the curves for jitter it can be seen that the optimum value for writing I3 marks and spaces is around 31 mW, whereas the equal length of marks and spaces occurs around 30 mW. The calculation unit 31 calculates the average values for the run lengths, and based on the run length mean value the optimum will be set at around 30 mW. In an embodiment an offset value is applied based on a known, structural deviation of the best laser power value for jitter versus the laser power for run length. The offset may for example be 3%, or 1 mW, additional power. The offset may be stored on the record carrier itself as indicated below, or may be located in a memory of the recording device.

In an embodiment the calculation means 31 are arranged for calculating a mean value of a parameter in dependence of the size of a space preceding the starting edge or following the ending edge of the mark. For example a mean value for the run length of an I3 mark is calculated by selecting only I3 marks that are preceded and followed by a space of at least a run length of 5. A correction signal 33 is calculated for such I3 marks. The write strategy in the laser power unit 29 may have specific, separate, adjustment options for I3 signals following short or long spaces, or for every possible preceding space run length.

FIG. 8 shows a parameter of a write strategy. In a horizontal direction 101 a parameter s is given and in a vertical direction 102 a deviation of the optimal run length. The resulting deviation curves 103 are given for I3 to I11. The parameter s gives the ratio of power in the write strategy used for the longer marks (e.g. I4 and longer) with respect to the power used for the shortest mark I3. Hence the power for I4 to I11=P_{(I4-I11)}=s*P_{I3}. It can be observed that in the case shown the value of s=0.7 seems best. However in practical circumstances the value of s can be optimized by measuring the average deviation of the length of the I3 marks and (separately) the lengths of the longer marks equal to or larger than I4 as described above.

In an embodiment of the device the calculation means are arranged for calculating a pre-heat effect of a mark. A pre-heat effect is the result of the heat dissipating from the preceding mark that just has been recorded, via the intermediate space, to the start of the next mark. Hence the pre-heat effect depends on the space preceding the starting edge of the mark. The pre-heat effect is calculated by comparing a first mean value calculated for a relative short space before the mark and a second mean value calculated for a relative long space before the mark.

In an embodiment the laser power unit 29 is arranged for controlling the power of the radiation source at the beginning of writing a mark in dependence of the pre-heat effect. In the write strategy the pre-heat effect is taken into account by reducing the power at the start of a mark if a short space precedes the mark. The reduction is adjusted based on the correction signal 33, in particular the difference in first and second mean value as calculated above.

In general in a recording device a write power should be set before starting recording. In order to set the initial write power properly an Optimum Power Control (OPC) procedure is done. For CD-R and DVD+/−R systems a so-called β OPC procedure is defined. In this procedure the parameter β, which is a measure for the asymmetry, is determined as a function of laser power. The calculation of β and circuitry for determining β are described in detail in U.S. Pat. No. 5,303,217.

In an embodiment of the device according to the invention the detection unit 32 is arranged for generating the signed deviation value signal during a special mode of the device, for example a start-up or calibration OPC mode. In the OPC mode test information is written, e.g. a test pattern having different run lengths. It is to be noted that the radiation source control unit 29 has been set to control the power of the radiation source during said test pattern writing at an optimum power. The optimum power and settings for the write strategy are according to predefined settings and/or previously generated values of the correction signal. It is to be noted that prior systems typically required writing test patterns at different settings of the write power to detect the sign of a deviation of the current optimum power settings (if any). However the current system allows calculating the correction signal 33 based on test patterns recorded at the best power settings known up to that moment. In a startup mode the known settings may be retrieved from pre-recorded recording information on the record carrier, or from a predefined write strategy in a memory of the device. In a calibration mode later on, e.g. in a background process, known optimum settings can be used, e.g. determined earlier when recording previous test patterns.

In an embodiment of the device the detection unit 32 is arranged for generating the signed deviation value signal during writing of user information. During user data writing the radiation source control unit obviously is controlling the power of the radiation source at an optimum power according to predefined settings and/or previously generated values of the correction signal. The writing of user data is temporarily interrupted for performing an optimum power control step, which is called walking optimum power control (WOPC). During said interruption the head is controlled to jump back to a part of the recorded pattern that just has been recorded. The part is read for generating the read signal, selecting the patterns of run lengths and calculation the correction signal as described above. Hence the correction signal (or signals) is (are) calculated based on the read signal retrieved during said interruption. User data arriving during the interruption may be stored in a buffer memory, whereas the speed of writing may be dimensioned to exceed the speed of user data to allow the interruption for OPC, and catch up subsequently.

In an embodiment of the record carrier control information is prerecorded on the record carrier for controlling the optimum power control process. For example the control information is encoded in the servo pattern, e.g. in the wobble or the pre-pits, or in a lead-in area of the disc which has pre-recorded information. For example a correction factor is pre-recorded for the correction as described above with FIG. 4 for correcting the optimum power based on run lengths, or a correction model to be used is indicated on the record carrier by the pre-recorded correction model parameters. Also other correction parameters may be included in the control information on the record carrier to adjust the correction to the specific record carrier.

Although the invention has been explained mainly by embodiments using the CD-R/RW, DVD−R or DVD+RW other recording systems can be used also like Blu-ray Disc (BD). It is noted that in this document the word recordable includes re-writable and recordable once. Also for the information carrier an optical disc has been described, but other media, such as optical card or tape, may be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information in a track (11) on a record carrier (4), the device comprising:
a head (22) for generating a beam of radiation for writing marks and spaces between the marks, and for generating at least one read signal in dependence on the marks and spaces, the marks and spaces each having a nominal run length of a predetermined number of bits, and the run lengths constituting a recorded pattern having a multitude of different run lengths for representing the information,
detection means (32) coupled to the read signal for generating a signed deviation value signal (34) indicative for a position deviation of a starting edge of a mark and/or an ending edge of a mark with respect to a nominal position of said edge,
calculation means (31) for selecting at least one predefined run length pattern and determining a correction signal (33) based on at least one statistically calculated parameter of the signed deviation value signal for the selected run length pattern, and
radiation source control means (29) for controlling the power of the radiation source during said writing in dependence of the correction signal.

2. Device as claimed in claim 1, wherein the calculation means (31) are arranged for calculating a mean value of the runlength between the starting edge and the ending edge of marks as the parameter of the signed deviation value signal.

3. Device as claimed in claim 1, wherein the calculation means (31) are arranged for calculating a mean value of the position deviation of the starting edge and/or the ending edge as the parameter of the signed deviation value signal.

4. Device as claimed in claim 1, wherein the calculation means (31) are arranged for selecting as the run length pattern marks and/or spaces nominally having
a single predefined run length, or
run lengths in a limited range of run lengths, or
a run length sequence including at least a mark and at least one space having predefined run lengths.

5. Device as claimed in claim 4, wherein the calculation means (31) are arranged for calculating a mean value of said parameter in dependence of the size of a space preceding the starting edge or following the ending edge of the mark.

6. Device as claimed in claim 5, wherein the calculation means (31) are arranged for calculating a pre-heat effect of a mark in dependence of the space preceding the starting edge of the mark by comparing a first mean value calculated for a relative short space before the mark and a second mean value calculated for a relative long space before the mark.

7. Device as claimed in claim 6, wherein the radiation source control means (29) are arranged for controlling the power of the radiation source at the beginning of writing a mark in dependence of the pre-heat effect.

8. Device as claimed in claim 1, wherein the detection means (32) are arranged for generating the signed deviation value signal during an optimum power control mode (OPC), in which mode test information is written and the radiation source control means are controlling the power of the radiation source during said writing at an optimum power according to predefined settings and/or previously generated values of the correction signal.

9. Device as claimed in claim 1, wherein the detection means (32) are arranged for generating the signed deviation value signal during said writing, during which writing the radiation source control means are controlling the power of the radiation source at an optimum power according to predefined settings and/or previously generated values of the correction signal, by temporarily interrupting said writing and during said interruption reading a part of the recorded pattern for generating the read signal.

10. Method of controlling the power of a radiation source during recording information in a track on a record carrier, the method comprising
writing and reading marks and spaces between the marks, the marks and spaces each having a nominal run length of a predetermined number of bits, and the run lengths constituting a recorded pattern having a multitude of different run lengths for representing the information,
generating a signed deviation value signal indicative for a position deviation of a starting edge of a mark and/or an ending edge of a mark with respect to a nominal position of said edge,
selecting at least one predefined run length pattern,
determining a correction signal based on at least one statistically calculated parameter of the signed deviation value signal for the selected run length pattern and
controlling the power of the radiation source during said writing in dependence of the correction signal.

11. Record carrier of a recordable type comprising a track for recording information, the recording comprising
writing and reading marks and spaces between the marks, the marks and spaces each having a nominal run length of a predetermined number of bits, and the run lengths constituting a recorded pattern having a multitude of different run lengths for representing the information, and
an optimum power control process including
generating a signed deviation value signal indicative for a position deviation of a starting edge of a mark and/or an ending edge of a mark with respect to a nominal position of said edge,
selecting at least one predefined run length pattern,
determining a correction signal based on at least one statistically calculated parameter of the signed deviation value signal for the selected run length pattern and
controlling the power of the radiation source during said writing in dependence of the correction signal,
the record carrier comprising prerecorded control information for adjusting the optimum power control process.
